(19) United States
(12) Patent Application Publication
(10) Pub. No.: US 2026/0246866 A1
(43) Pub. Date: Aug. 20, 2026

(54) TOUCH ACTIVATED ZOOM BUTTON STRUCTURE AND ELECTRONIC DEVICE PROTECTIVE CASE

(71) Applicant: TK Precision Plastics (Shenzhen) Limited, Shenzhen (CN)

(72) Inventors: Biao Li, Shenzhen (CN); YouYin Xia, Shenzhen (CN)

(21) Appl. No.: 19/236,985

(22) Filed: Jun. 13, 2025

(30) Foreign Application Priority Data
Feb. 19, 2025 (CN) 202520264503.3

(51) Int. Cl. H04M 1/72409

(52) U.S. Cl. CPC H04M 1/724092

(57) ABSTRACT

A touch wake-up zoom button structure and an electronic device protective case are provided. The touch wake-up zoom button structure includes a soft rubber structure provided in a button slot, a clamp slot provided in the soft rubber structure; a hard rubber button provided in the clamp slot and including a pressing portion, a shaft portion extending from one side of the pressing portion, and a triggering portion. The shaft portion is provided between the pressing portion and the triggering portion, and the triggering portion is configured to trigger a pressing signal; upper and lower ends of the hard rubber button are provided with an accommodating slot; a conductive silicone strip fixedly provided in the accommodating slot and configured for electrical connection with a capacitive sensing part of a device. By adopting this structure, the touch wake-up zoom of an electronic device has been achieved.

### CROSS-REFERENCE TO RELATED APPLICATIONS

This application claims priority to Chinese Patent Application No. 2025202645033, filed on February 19, 2025, which is hereby incorporated by reference in its entirety.

### TECHNICAL FIELD

The present disclosure relates to the field of electronic devices technologies, and in particular, to a touch activated zoom button structure and an electronic device protective case.

### BACKGROUND

With the popularity of digital products and the increasing demand for device portability and durability from users, camera cases and phone cases, as important accessories, not only need to provide physical protection, but also need to consider functional design. The wake-up and zoom buttons are indispensable functional components in the protective case, directly affecting the user’s operating experience. The button design of traditional mobile phone cases and camera cases usually use conductive metal buttons that rely on physical contact. Long term use can easily cause wear and tear on the device buttons, thereby leading to button failure or damage.

Therefore, there is an urgent need to provide a touch activated zoom button structure and an electronic device protective case to solve the above problems.

### SUMMARY

The purpose of the present disclosure is to overcome the shortcomings and deficiencies of existing technology, provides a touch activated zoom button structure, and achieves touch wake-up zoom for an electronic device. The button structure has good flexibility and conductivity, can better contact with device button, is not easily damaged and has low cost.

The purpose of the present disclosure is achieved through the following technical solutions.

A touch activated zoom button structure, which is provided in a button slot in a housing, and the touch activated zoom button structure includes:

a soft rubber structure, which is provided in the button slot, a clamp slot is provided in the soft rubber structure;

a hard rubber button, which is provided in the clamp slot and includes a pressing portion, a shaft portion extending from one side of the pressing portion, and a triggering portion; the shaft portion is provided between the pressing portion and the triggering portion, and the triggering portion is configured to trigger a pressing signal; upper and lower ends of the hard rubber button are provided with an accommodating slot;

a conductive silicone strip, which is fixedly provided in the accommodating slot and configured for electrical connection with a capacitive sensing part of a device.

In some embodiments of the present disclosure, a circular inner groove is provided around an outer side of the pressing portion, an outer side of the shaft portion, and an outer side of the triggering portion; the soft rubber structure is clamping connected to the circular inner groove.

In some embodiments of the present disclosure, the conductive silicone strip includes multiple sets of conductive sections and multiple sets of insulating sections; the conductive sections and insulating sections are alternately stacked at intervals; the conductive sections have a thickness of 0.025-0.5mm, and the insulating sections have a thickness of 0.025-0.5mm.

In some embodiments of the present disclosure, the soft rubber structure includes a connection section, an elastic section, and an installation section, where the elastic section is provided between the connection section and the installation section; one end of the connection section is connected to the housing, and the other end thereof is connected to the elastic section; the installation section is clamping connected to the circular inner groove.

In some embodiments of the present disclosure, a cross-section of the elastic section is a U-shape; a platform layer is formed at a connection between the elastic section and the connection section; a distance between the platform layer and a lower end face of the triggering portion is 0.1-0.2mm.

In some embodiments of the present disclosure, the U-shape elastic section has a thickness of 0.1~0.5mm.

In some embodiments of the present disclosure, a height of the conductive silicone strip is greater than a height of the triggering portion.

In some embodiments of the present disclosure, the elastic section on left and right sides of the soft rubber structure is penetrated through; upper and lower ends of the elastic section with the connection section and the installation section form a C-shaped groove.

In some embodiments of the present disclosure, an upper of the pressing portion and an upper of the conductive silicone strip are provided with a decorative sheet, and the decorative sheet is a polyethylene terephthalate (PET) sheet or a glass sheet, and a double-sided adhesive strip is provided between the decorative sheet and the conductive silicone strip.

In order to achieve the above objectives, the present disclosure provides an electronic device protective case, which includes the touch wake-up zoom button structure.

Compared with existing technologies, the present disclosure has the following beneficial effects.

In the present disclosure, the touch wake-up zoom button structure includes the soft rubber structure, the hard rubber button, and the conductive silicone strip. The soft rubber structure is provided in the button slot, and the clamp slot is provided in the soft rubber structure. The hard rubber button is provided in the clamp slot, and the hard rubber button includes the pressing portion, the shaft portion extending from one side of the pressing portion, and the triggering portion. The shaft portion is provided between the pressing portion and the triggering portion. The upper and lower ends of the hard rubber button are provided with the accommodating slot, and conductive silicone strip is fixedly provided in the accommodating slot. The conductive silicone strip is configured to electrically connect with the capacitive sensing part of the device. Due to the conductive effect of the conductive silicone strip, corresponding operations can be achieved by detecting changes in capacitance caused by human touch, that is, touch wake-up or zoom. Compared to conventional conductive metal strips, the conductive silicone strip has lower hardness and a certain degree of flexibility, which can better wrap and contact with button, and also avoids a direct contact with the device button and damaging them. They also have elasticity and good hand feel after long-term use and are cost-effective. Through the settings of the above components, touch wake-up zoom for an electronic device has been achieved. The button structure has good flexibility and conductivity, which can better contact the device button, prevent damage to the device button and have low cost.

### BRIEF DESCRIPTION OF DRAWINGS

FIG. 1 shows a structural diagram of the present disclosure.

FIG. 2 is a partial cross-sectional view taken along line B-B in FIG. 1.

FIG. 3 is another schematic structural diagram of the present disclosure.

FIG. 4 is a schematic structural diagram of a soft rubber in the present disclosure.

FIG. 5 is an exploded structural view of the present disclosure.

FIG. 6 is a schematic structural diagram of a hard rubber button in the present disclosure.

FIG. 7 is a schematic structural diagram of a conductive silicone strip in the present disclosure.

Numeral reference: 1- housing, 2- soft rubber structure, 21- connection section, 22- elastic section, 23- installation section, 24- platform layer, 25- C-shaped groove, 3- hard rubber button, 31- pressing portion, 32- shaft portion, 33- triggering portion; 34- accommodating slot, 35- circular inner groove, 4- conductive silicone strip, 41- conductive section, 42- insulating section, 5- decorative sheet, 6- double-sided adhesive strip.

### DESCRIPTION OF EMBODIMENTS

The following provides a further detailed description of the present disclosure in combination with the embodiments and accompanying drawings, but the embodiments of the present disclosure are not limited to this.

The technical solution of the present disclosure provides a touch wake-up zoom button structure and an electronic device protective case, which is provided in a button slot in a housing 1.

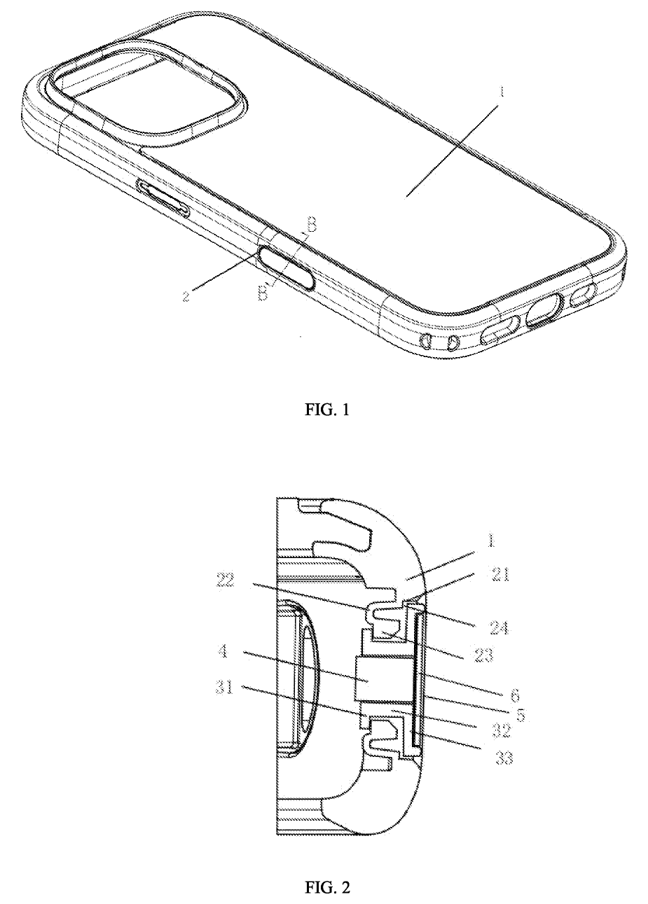

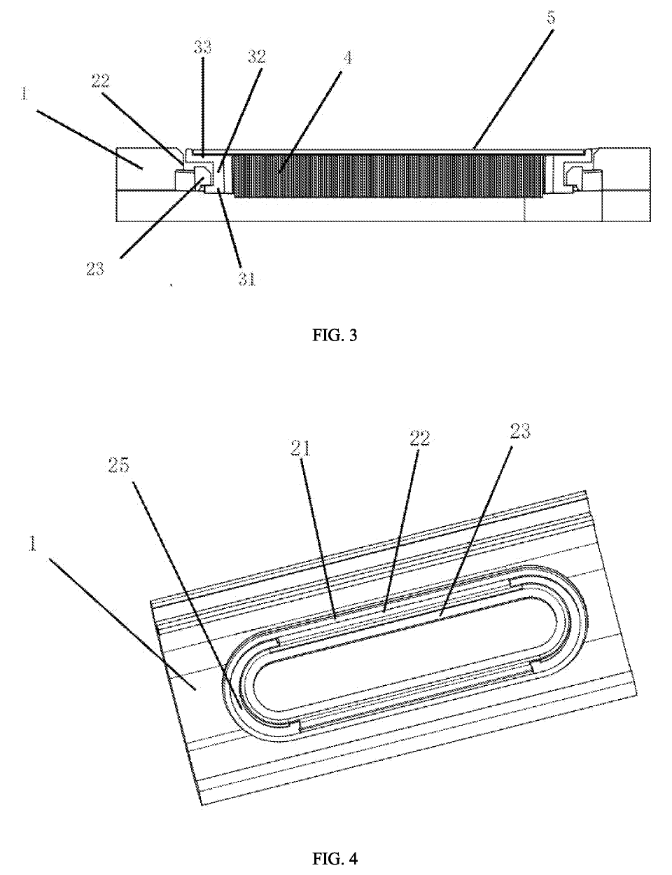

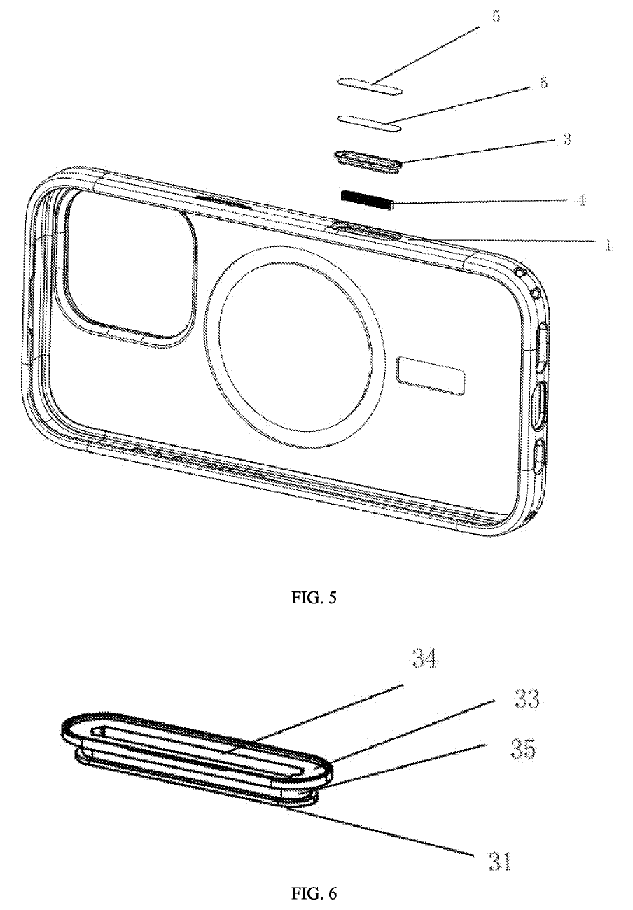

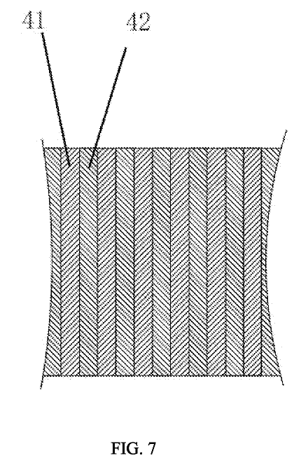

Referring to FIGS. 1 to 7, in this embodiment, the touch wake-up zoom button structure includes:

a soft rubber structure 2, which is provided in a button slot, and a clamp slot 23 is provided in the soft rubber structure 2;

a hard rubber button 3, which is provided in the clamp slot 23 and includes a pressing portion 31, a shaft portion 32 extending from one side of the pressing portion 31, and a triggering portion 33; the shaft portion 32 is provided between the pressing portion 31 and the triggering portion 33, and the triggering portion 33 is configured to trigger a pressing signal; upper and lower ends of the hard rubber button 3 are provides with an accommodating slot 34;

a conductive silicone strip 4, which is fixedly provided in the accommodating slot 34 and is configured to electrically connect with a capacitive sensing part of a device.

In an implementation mode, the touch wake-up zoom button structure is provided in the button slot inside the housing 1, and the touch wake-up zoom button structure includes the soft rubber structure 2, the hard rubber button 3, and the conductive silicone strip 4. The soft rubber structure 2 is provided in the button slot, and the clamp slot 23 is provided in the soft rubber structure 2. The hard rubber button 3 is provided in the clamp slot 23 and includes the pressing portion 31, the shaft portion 32 extending from one side of the pressing portion 31 and the triggering portion 33. The shaft portion 32 is provided between the pressing portion 31 and the triggering portion 33; the pressing portion 31, the shaft portion 32, and the triggering portion 33 are integrated for easy processing and molding. By pressing the pressing portion 31, the pressing signal is transmitted to the triggering portion 33 through the shaft portion 32, and the triggering portion 33 is configured to trigger the pressing signal. The upper and lower ends of the hard rubber button 3 are provided with the accommodating slot 34, and the conductive silicone strip 4 is fixedly provided in the accommodating slot 34. The conductive silicone strip 4 is configured to electrically connect with the capacitive sensing part of the device, that is, by the operator pressing the pressing portion 31, the shaft portion 32 transmits pressure, the triggering portion 33 triggers the pressing signal, and at the same time the conductive silicone strip 4 is driven to move and come into contact with the capacitive sensing part of the device. Due to a conductive effect of the conductive silicone strip 4, the corresponding operation is achieved by detecting the capacitance change caused by human touch, that is, realizing touch wake-up or zoom. By setting the soft rubber structure, a certain buffer is provided for the hard rubber button to avoid excessive pressure between the hard rubber button and the device button, which may cause damage to the button. Compared to conventional conductive metal strips, the conductive silicone strip 4 has lower hardness and a certain degree of flexibility, which can better wrap and contact the button and also avoid a direct contact with the device button and damaging them. It also has elasticity and good hand feel after long-term use and has lower cost. Through the settings of the above components, touch wake-up zoom for an electronic device has been achieved. The button structure has good flexibility and conductivity, which can better contact the device button, prevent damage to the device button and have low cost.

In this embodiment, a circular inner groove is provided around an outer side of the pressing portion, an outer side of the shaft portion, and an outer side of the triggering portion. The soft rubber structure is clamping connected to the circular inner groove, and the soft rubber structure is clamping connected to the circular inner groove. Thus, the connection is tight. Besides that, the soft rubber structure includes a connection section 21, an elastic section 22, and an installation section 23. The elastic section 22 is provided between the connection section 21 and the installation section 23; one end of the connection section 21 is connected to the housing and the other end thereof is connected to the elastic section 22. The installation section 23 is also clamping connected to the circular inner groove. Due to a height of the conductive silicone strip 4 is greater than a height of the triggering portion, that is, when the device is provided in the housing, the conductive silicone strip 4 is in interference fit connection with the device button, and the device button pushes the conductive silicone strip 4 to move outward. As the installation section 23 is clamped with the circular inner groove, the conductive silicone strip 4 is in interference fit connection with the hard rubber button, that is, when the conductive silicone strip 4 moves outward, the installation section 23 drives the elastic section 22 to move, thereby causing a deformation of the elastic section 22. The soft rubber structure is thermoplastic urethane (TPU) soft rubber, which is a high-performance elastic material with high elasticity and wear resistance. Therefore, the elastic section 22 has a tendency to recover deformation after deformation, and a resulting recovery force enables the soft rubber structure and conductive silicone strip 4 to tightly adhere to the device button. Thus, the connection is tight.

In this embodiment, a cross-section of the elastic section 22 is a U-shape, and a thickness of the U-shaped elastic section 22 is 0.1~0.5mm, so that the U-shaped structure has good elasticity and will not undergo irreversible deformation due to thickness. In an implementation mode, the cross-section of the elastic section 22 can also be arranged in a V-shape, which is not limited here. A platform layer 24 is provided at a connection between the elastic section 22 and the connection section 21, and the platform layer 24 is used to make contact with a lower end surface of the triggering portion. A distance between the platform layer 24 and a lower end surface of the triggering portion is 0.1-0-0.2mm, that is, the platform layer 24 is configured to limit a pressing distance of the hard rubber button, thereby preventing damage to the device button caused by excessive pressing force due to excessive pressing distance.

In this embodiment, the conductive silicone strip 4 includes a conductive section 41 and an insulating section 42, there are a plurality of conductive sections 41 and a plurality of insulating sections 42; and the conductive sections 41 and the insulating sections 42 are alternately spaced and stacked to form the conductive silicone strip 4. The conductive sections 41 have a thickness of 0.025-0.5mm, and the insulating sections 42 have a thickness of 0.025-0.5mm.

In this embodiment, the elastic sections 22 at left and right of the soft rubber structure are penetrated, that is, the upper and lower of the elastic sections 22 with the connection section 21 and the installation section 23 form a C-shaped groove 25. The elastic sections 22 on the left and right sides of the soft rubber structure are cut off, and only the elastic sections 22 on the upper and lower ends are retained. By reducing the elastic sections 22 of the U-shaped structure, a recovery force generated by a deformation of the U-shaped structure under compression is reduced, thereby preventing the button from being damaged or the connection from being too tight due to excessive recovery force.

In this embodiment, an upper of the pressing portion and an upper of the conductive silicone strip 4 are provided with a decorative sheet 5, and the decorative sheet 5 is a PET sheet or a glass sheet. Both PET sheet and glass sheet have high transparency, high strength, and beautiful appearance. By providing a double-sided adhesive strip 6 between the decorative sheet 5 and the conductive silicone strip 4, a tight connection between the decorative sheet 5 and the conductive silicone strip 4 can be achieved, and the contact between the conductive silicone strip 4 and an external environment can be isolated, thereby protecting the service life of the product.

The present disclosure further provides an electronic device protective case, which has the above-mentioned touch wake-up zoom button structure, thereby achieving better touch wake-up zoom of the device. The electronic device protective case can be a phone case or a camera case. The electronic device protective case has the above-mentioned button structure, which can control a touch wake-up function of the electronic device accommodated in the protective case and achieve touch zoom to enhance a user experience.

What is claimed is:

1. A touch activated zoom button structure, which is provided in a button slot in a housing, and the touch activated zoom button structure comprises:
a soft rubber structure, which is provided in the button slot, a clamp slot is provided in the soft rubber structure;
a hard rubber button, which is provided in the clamp slot and comprises a pressing portion, a shaft portion extending from one side of the pressing portion, and a triggering portion; the shaft portion is provided between the pressing portion and the triggering portion, and the triggering portion is configured to trigger a pressing signal; upper and lower ends of the hard rubber button are provided with an accommodating slot;
a conductive silicone strip, which is fixedly provided in the accommodating slot and configured for electrical connection with a capacitive sensing part of a device.

2. The touch activated zoom button structure according to claim 1, wherein a circular inner groove is provided around an outer side of the pressing portion, an outer side of the shaft portion, and an outer side of the triggering portion;
the soft rubber structure is clamping connected to the circular inner groove.

3. The touch activated zoom button structure according to claim 1, wherein the conductive silicone strip comprises multiple sets of conductive sections and multiple sets of insulating sections, and the conductive sections and insulating sections are alternately stacked at intervals;
the conductive sections have a thickness of 0.025-0.5mm, and the insulating sections have a thickness of 0.025-0.5mm.

4. The touch activated zoom button structure according to claim 2, wherein the soft rubber structure comprises a connection section, an elastic section, and an installation section,
wherein the elastic section is provided between the connection section and the installation section,
one end of the connection section is connected to the housing, and the other end thereof is connected to the elastic section;
the installation section is clamping connected to the circular inner groove.

5. The touch activated zoom button structure according to claim 4, wherein a cross-section of the elastic section is a U-shape;
a platform layer is formed at a connection between the elastic section and the connection section;
a distance between the platform layer and a lower end face of the triggering portion is 0.1-0.2mm.

6. The touch activated zoom button structure according to claim 5, wherein the U-shape elastic section has a thickness of 0.1~0.5mm.

7. The touch activated zoom button structure according to claim 2, wherein a height of the conductive silicone strip is greater than a height of the triggering portion.

8. The touch activated zoom button structure according to claim 5, wherein the elastic section on left and right sides of the soft rubber structure is penetrated through;
upper and lower ends of the elastic section with the connection section and the installation section form a C-shaped groove.

9. The touch activated zoom button structure according to claim 1, wherein an upper of the pressing portion and an upper of the conductive silicone strip are provided with a decorative sheet, and the decorative sheet is a polyethylene terephthalate (PET) sheet or a glass sheet, and a double-sided adhesive strip is provided between the decorative sheet and the conductive silicone strip.

10. An electronic device protective case, comprising the touch wake-up zoom button structure according to claim 1.
